(19) United States
(12) Patent Application Publication
(10) Pub. No.: US 2019/0279306 A1
(43) Pub. Date: Sep. 12, 2019

(54) SYSTEM AND METHOD FOR AUDITING INSURANCE CLAIMS

(71) Applicant: Cognizant Technology Solutions India Pvt. Ltd., Chennai (IN)

(72) Inventors: Mark Wassel, Geneva, IL (US); Shankar Muthukumaraswamy, Chennai (IN); Aditi Saraf, San Francisco, CA (US)

(21) Appl. No.: 15/975,001

(22) Filed: May 9, 2018

(30) Foreign Application Priority Data
Mar. 9, 2018 (IN) 201841008784

(51) Int. Cl. G06Q 40/08; G06Q 40/00

(52) U.S. Cl. CPC G06Q 40/08; G06Q 40/12

(57) ABSTRACT

A system, computer-implemented method and computer program product for auditing insurance claims is provided. The system comprises a source data extractor configured to extract one or more claim records from one or more sources. The system further comprises a transformation engine configured to transform the one or more received claim records to a data model and load the data model to a claims audit database. Furthermore, the system comprises a segmentation engine configured to interrogate the claims audit database and categorize each claim record within the loaded data model into one or more pre-defined categories. The system also comprises a claims audit engine configured to execute one or more audit rules and generate at least one of: audit information and one or more alerts corresponding to each of the one or more claim records based on results of the one or more executed audit rules.

### FIELD OF THE INVENTION

The present invention relates generally to auditing insurance claims. More particularly, the present invention provides a system and method for auditing insurance claims to reduce claims leakage.

### BACKGROUND OF THE INVENTION

Claims leakage is the money lost through claims management inefficiencies resulting from errors and missed steps by claim adjusters. The insurance industry estimates claims leakage to approximately seven percent of the claims paid. Insurance companies endeavor to minimize claims leakage to reduce costs and increase profits.

Conventionally, claims leakage is managed through closed file reviews. Closed file reviews are manual and detailed audits conducted on small samples of adjusters' files to identify source of leakage and leverage the findings to coach and mentor adjusters. Closed file reviews promote appropriate conduct and investigations by adjusters in future claim settlements. However, since reviews are conducted on closed files there is no opportunity to correct the outcome of the claim prior to settlement. To overcome the above-mentioned drawbacks, insurance companies desire managers to conduct reviews on active claim files. However, managers have numerous claim adjusters under them and claim adjusters have hundreds of active claim files allocated at a time thus reducing the number of active file reviews. This results in limited opportunities to scrutinize performance of the adjuster and identifying areas of strengths and weaknesses. Moreover, as reviews are manual, it becomes difficult to analyze the results of the review, track performance of the adjusters against key attributes across all assigned files and simplify the identification of trends and opportunities for improvements. In order to overcome the limitations of manual file reviews, insurance companies use existing claims administration systems. However, the existing claims administration systems also suffer from several disadvantages. The existing claims administration systems provide only one-off audits of certain activities in a claim lifecycle. The existing claims administration systems do not provide comprehensive auditing throughout the lifecycle of all active claims and across various performance and outcome attributes. Also, the existing claims administration systems do not direct managers to problematic claim files in their portfolio and therefore do not provide any opportunity for correcting the outcome of the claim prior to settlement.

In light of the above-mentioned disadvantages, there is a need for a system and method for auditing insurance claims prior to claim settlement. There is a need for a system and method that allows comprehensive and systemic audit of all active claim files. Further, there is a need for a multi-variant claims data analytics system for auditing active claims across multiple performance and outcome attributes, flagging problematic claims and advising managers of the issues occurring on the file thereby providing opportunity for course correction prior to settlement. Furthermore, there is a need for a system and method that is capable of tracking performance of claim adjusters against key performance attributes on all assigned files and providing insight into adjusters' strengths and opportunities for improvement.

### SUMMARY OF THE INVENTION

A system, computer-implemented method and computer program product for auditing insurance claims is provided. The system comprises a source data extractor configured to extract one or more claim records from one or more sources. The system further comprises a transformation engine configured to transform the one or more received claim records to a data model, wherein the data model comprise information present in the one or more received claim records in a pre-defined and structured format and load the data model to a claims audit database. Furthermore, the system comprises a segmentation engine configured to interrogate the claims audit database and categorize each claim record within the loaded data model into one or more pre-defined categories. The system also comprises a claims audit engine configured to execute one or more predefined audit rules corresponding to each of the one or more categories for auditing each of the one or more claim records and generate at least one of: audit information and one or more alerts corresponding to each of the one or more claim records based on results of the one or more executed audit rules.

In an embodiment of the present invention, the one or more sources comprise claim administration systems employed by one or more insurance carriers, document repositories, media repositories and third party sources. In an embodiment of the present invention, the one or more pre-defined categories are configured by one or more insurance carriers based on type of insurance, complexity of claim and type of loss. In an embodiment of the present invention, the one or more predefined audit rules are executed based on category and stage of each of the one or more claim records. In an embodiment of the present invention, the claims audit engine executes the one or more predefined audit rules corresponding to one or more audit events and further wherein the one or more audit events comprise activity audit, document audit, progress audit, engagement audit, vendor management audit and inconsistency audit.

In an embodiment of the present invention, the generated audit information comprise information related to one or more audit events conducted at specific stages of the claim, results of each audit event, results of the execution of the one or more predefined audit rules and status of the one or more claim records. In an embodiment of the present invention, the one or more alerts comprise summary of the results of the audit conducted by the claims audit engine for each of the one or more claim records. In an embodiment of the present invention, the one or more alerts corresponding to each of the one or more claim records are forwarded via one or more communication channels. Further, the one or more communication channels comprise electronic mails, short messaging service, facsimile and instant messengers. In an embodiment of the present invention, the system further comprises a user interface manager configured to provide at least one: of the generated audit information and the one or more alerts in the form of summarized dashboards and detailed insights.

The computer-implemented method for auditing insurance claims, via program instructions stored in a memory and executed by a processor comprises extracting one or more claim records from one or more sources. The computer-implemented method further comprises transforming the one or more received claim records to a data model, wherein the data model comprise information present in the one or more received claim records in a pre-defined and structured format. Furthermore, the computer-implemented method comprises loading the data model to a claims audit database, interrogating the claims audit database and categorizing each claim record within the loaded data model into one or more pre-defined categories. Also, the computer-implemented method comprises executing one or more predefined audit rules corresponding to each of the one or more pre-defined categories for auditing each of the one or more claim records. The computer-implemented method further comprises generating at least one of: audit information and one or more alerts corresponding to each of the one or more claim records based on results of the one or more executed audit rules.

The computer program product for auditing insurance claims comprises a non-transitory computer-readable medium having computer-readable program code stored thereon, the computer-readable program code comprising instructions that when executed by a processor, cause the processor to extract one or more claim records from one or more sources. The processor further transforms the one or more received claim records to a data model, wherein the data model comprise information present in the one or more received claim records in a pre-defined and structured format. Furthermore, the processor loads the data model to a claims audit database, interrogates the claims audit database and categorizes each claim record within the loaded data model into one or more pre-defined categories. The processor also executes one or more predefined audit rules corresponding to each of the one or more pre-defined categories for auditing each of the one or more claim records. The processor further generates at least one of: audit information and one or more alerts corresponding to each of the one or more claim records based on results of the one or more executed audit rules.

### BRIEF DESCRIPTION OF THE ACCOMPANYING DRAWINGS

The present invention is described by way of embodiments illustrated in the accompanying drawings wherein:

FIG. 1 is a block diagram illustrating a system for auditing insurance claims, in accordance with an embodiment of the present invention;

FIG. 1A is a table illustrating sample audit rules, in accordance with an exemplary embodiment of the present invention;

FIG. 1B is a detailed block diagram of the user interface manager, in accordance with an exemplary embodiment of the present invention;

FIG. 1C is a screenshot of the manager dashboard page illustrating summary of claims based on their status, in accordance with an exemplary embodiment of the present invention;

FIG. 1D is a screenshot of the manager dashboard page illustrating summary of claims based on flagging from the audit, in accordance with an exemplary embodiment of the present invention;

FIG. 1E is a screenshot of claim insights page illustrating claim details, in accordance with an exemplary embodiment of the present invention;

FIG. 1F is a screenshot of claim insights page illustrating options for filtering the claims, in accordance with an exemplary embodiment of the present invention;

FIG. 1G is a screenshot illustrating a pie chart populated by filtering the claims based on attorney involvement, in accordance with an exemplary embodiment of the present invention;

FIG. 1H is a screenshot of a weekly claim status report, in accordance with an exemplary embodiment of the present invention;

FIG. 1I is a screenshot of audit insights page provided by the audit insight module, in accordance with an exemplary embodiment of the present invention;

FIG. 1J is a screenshot of the adjuster performance page, in accordance with an exemplary embodiment of the present invention;

FIG. 2 is a flowchart illustrating a method for auditing insurance claims, in accordance with an embodiment of the present invention; and

FIG. 3 illustrates an exemplary computer system for auditing insurance claims, in accordance with an embodiment of the present invention.

### DETAILED DESCRIPTION OF THE INVENTION

A system and method for auditing insurance claims prior to claim settlement is described herein. The invention provides for a system and method that allows comprehensive and systemic audit of active claim files. The invention further provides for a multi-variant claims data analytics system and method for auditing active claims across multiple performance and outcome attributes. Furthermore, the invention provides for a system and method for flagging problematic claims and advising managers of the issues occurring on the file thereby providing opportunity for course correction prior to settlement. In addition, the invention provides for a system and method that is capable of tracking performance of claim adjusters against key performance attributes on all assigned files and providing insight into adjusters' strengths and opportunities for improvement. The invention also provides for a system and method that is capable of reducing leakage by timely identifying errors, omissions and inconsistencies, redefining adjuster and Third Party Administrator (TPA) assessment, using coaching and mentoring model, improving manager efficiency and effectiveness, eliminating manual file reviews and associated costs and assessing adjusters' performance with respect to different types of claims.

The following disclosure is provided in order to enable a person having ordinary skill in the art to practice the invention. Exemplary embodiments are provided only for illustrative purposes and various modifications will be readily apparent to persons skilled in the art. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

The present invention would now be discussed in context of embodiments as illustrated in the accompanying drawings.

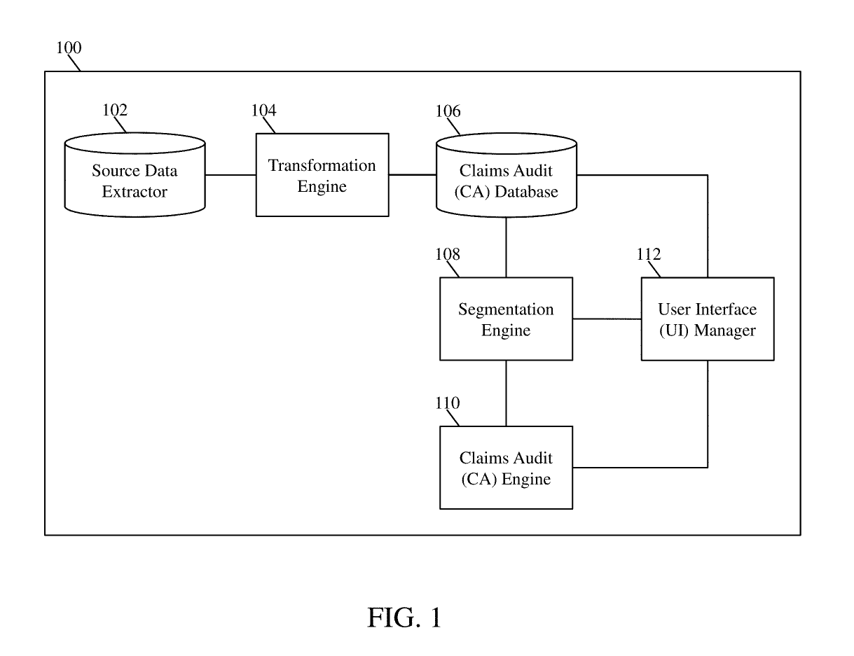

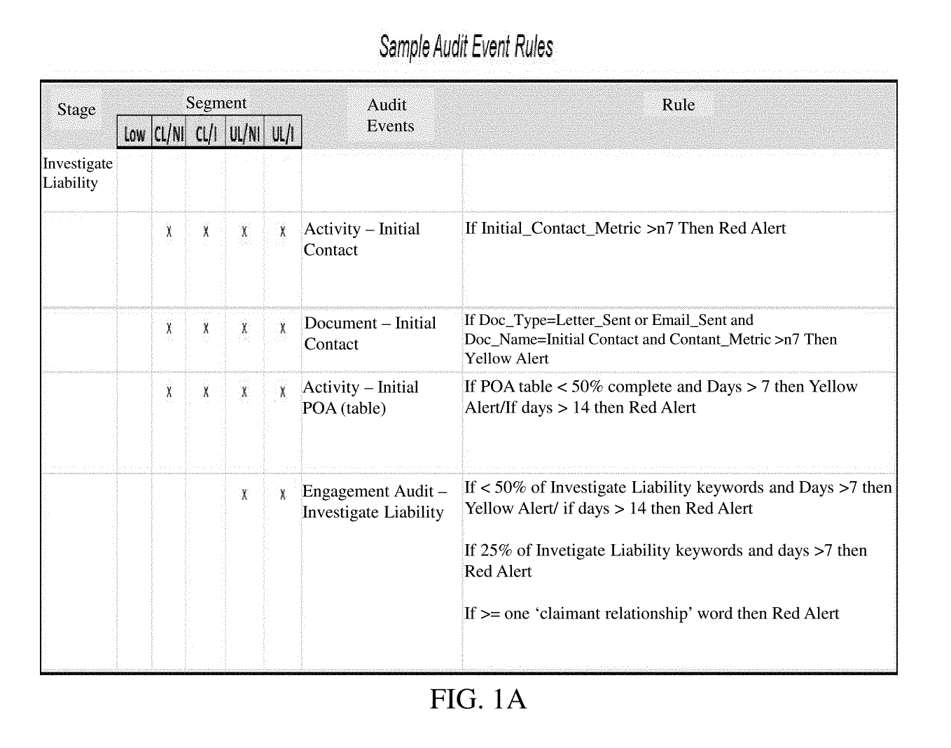

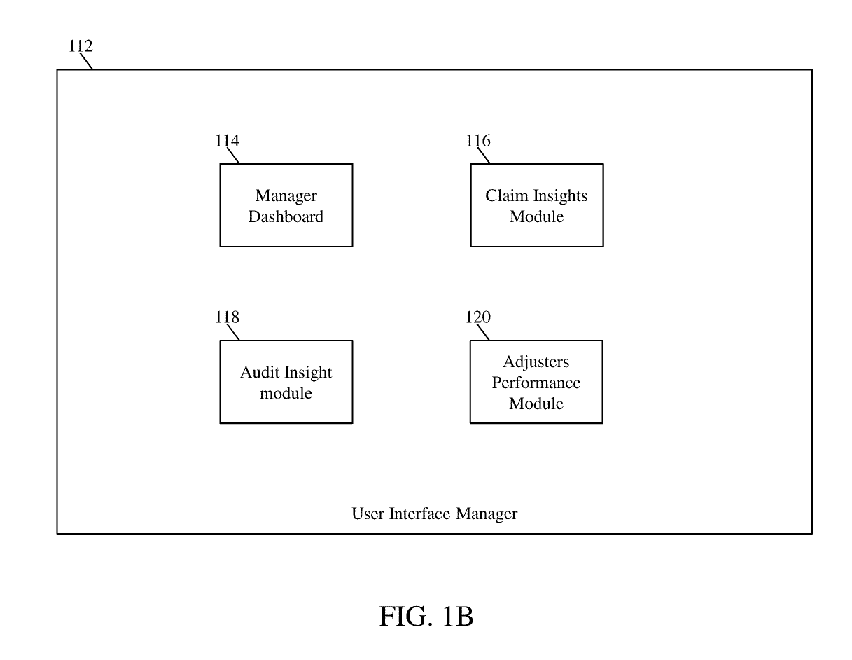

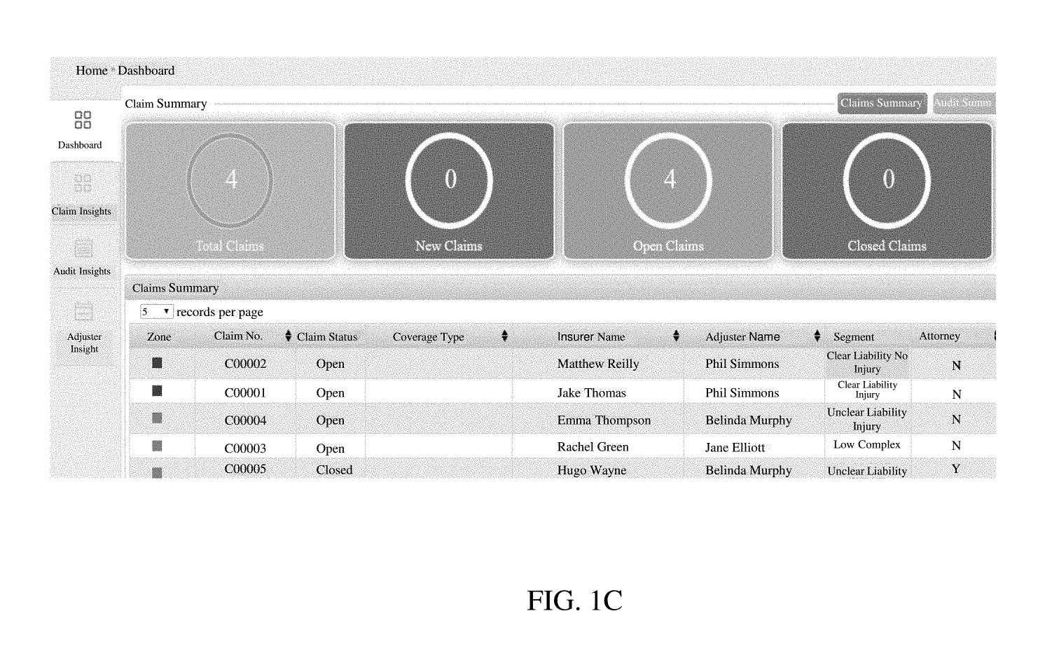

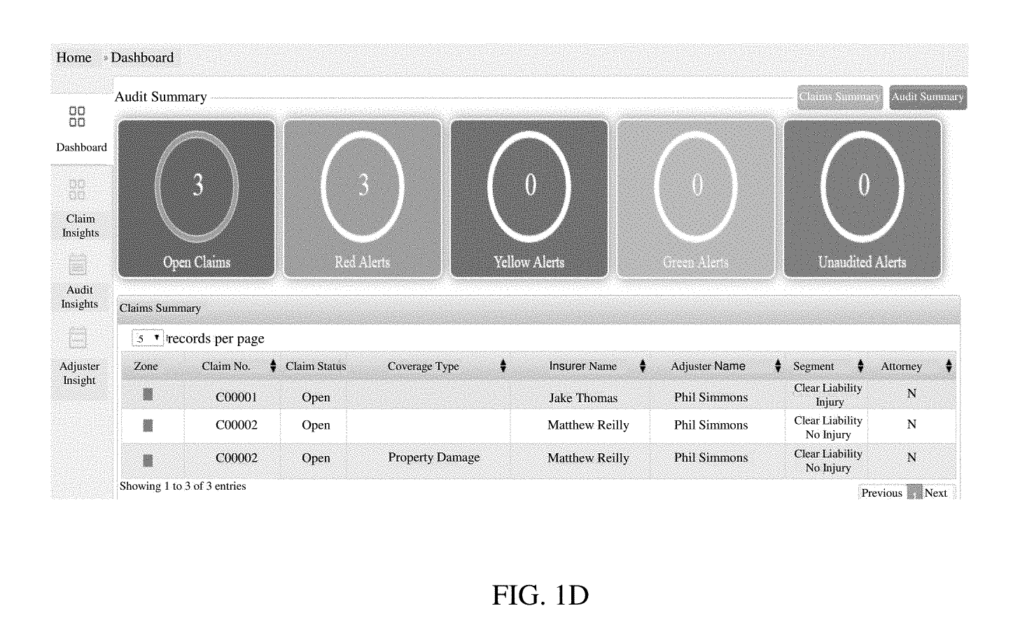

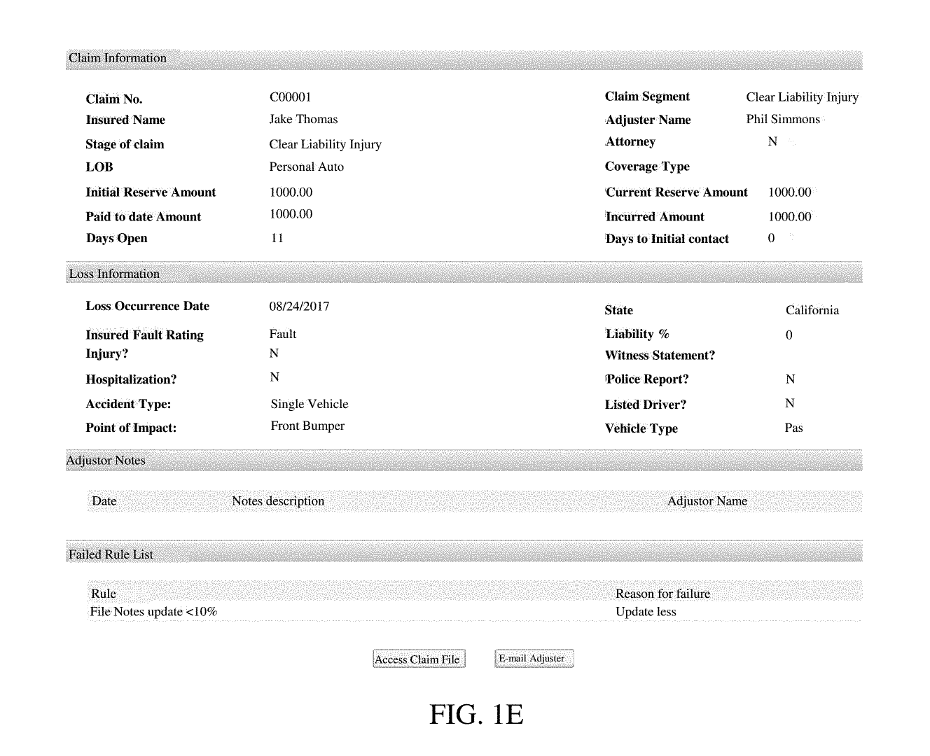

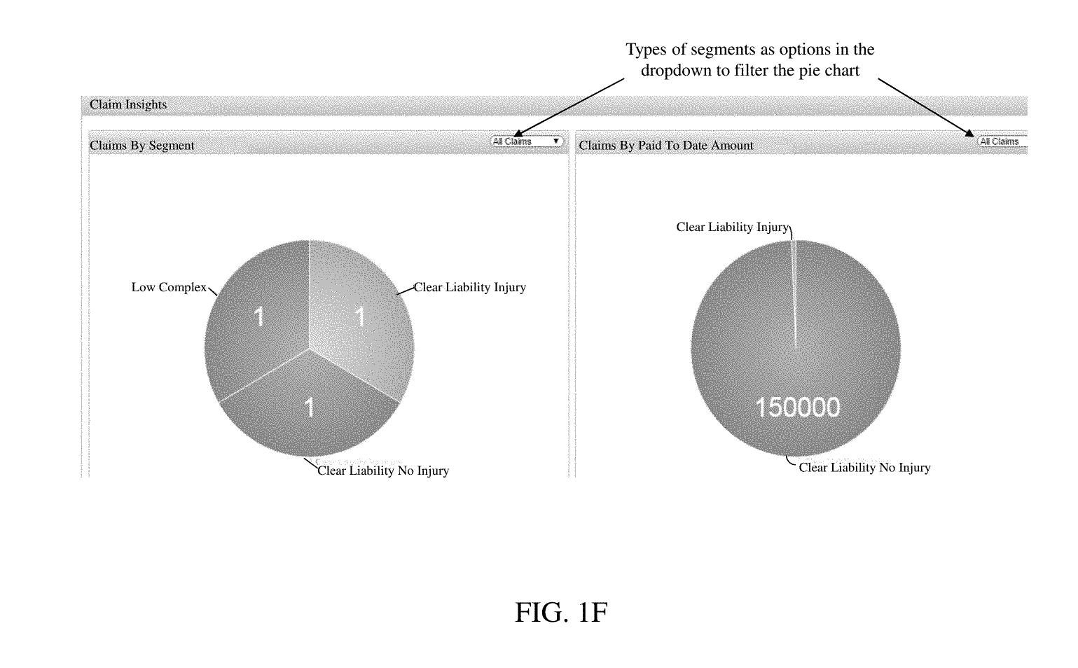

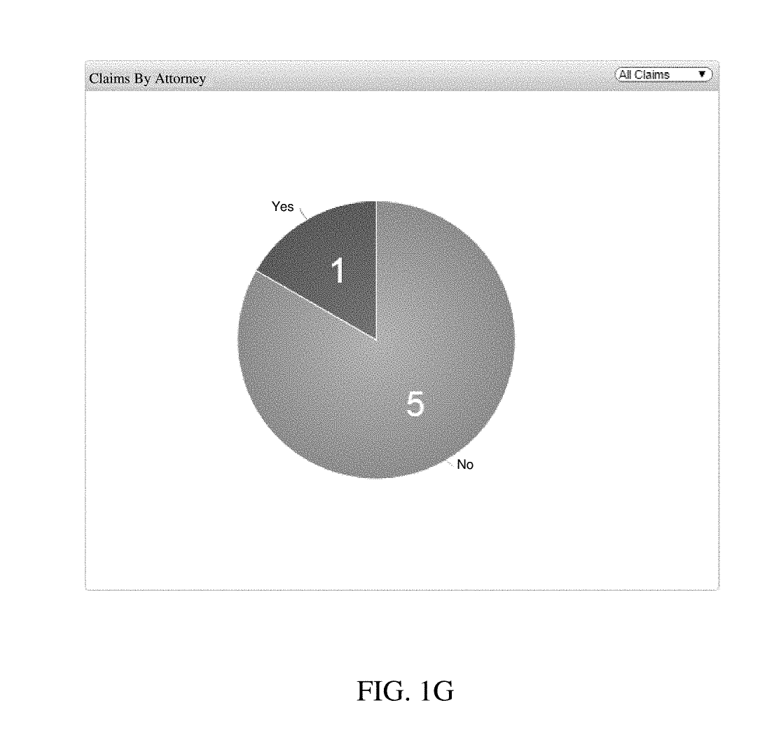

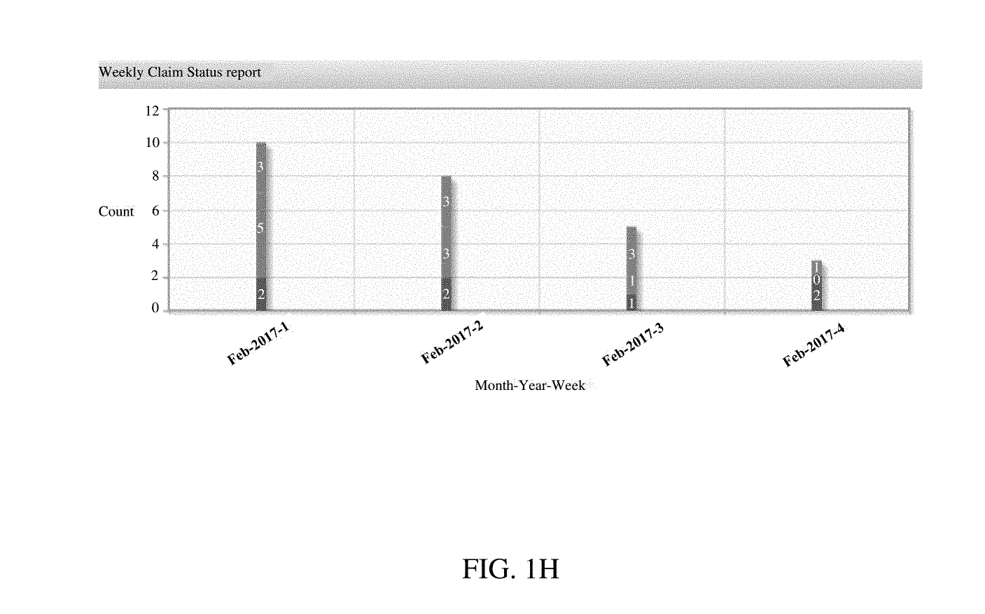

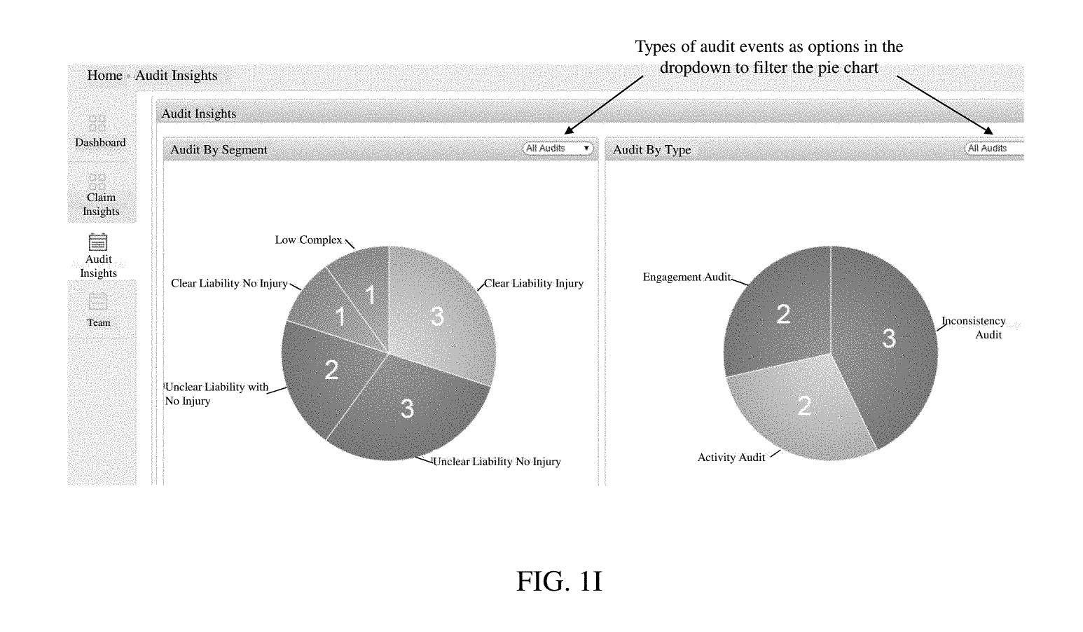

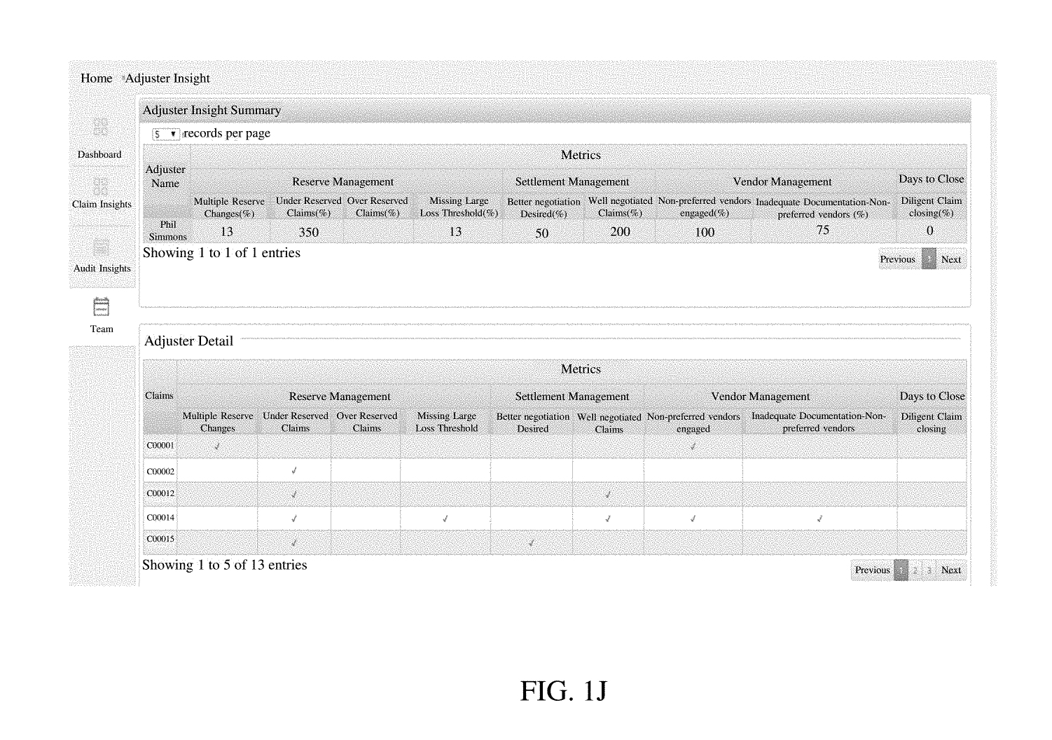

FIG. 1 is a block diagram illustrating a system 100 for auditing insurance claims, in accordance with an embodiment of the present invention. The system 100 comprises a source data extractor 102, a transformation engine 104, a claims audit database 106, a segmentation engine 108, a claims audit engine 110 and a User Interface (UI) manager 112.

The source data extractor 102 is configured to extract one or more claim records from one or more sources. The one or more sources include, but not limited to, existing systems such as claim administration systems employed by one or more insurance carriers for managing insurance claims, document repositories, media repositories and third party sources. The media repositories store media such as, but not limited to, images, audio files and video files. The third party sources provide information such as, but not limited to, industry standards, weather information and maps that is useful in determining settlement amount and settling insurance claims. In an embodiment of the present invention, the claim records and pertinent information are extracted from one or more data feeds, documents and media provided by the one or more sources. In an embodiment of the present invention, the one or more data feeds include, but not limited to, information in a predefined format which is prepared and transmitted by existing systems or third party sources. In an embodiment of the present invention, the one or more documents include, but not limited to, first loss notice, medical records, medical bills, official reports such as police reports and witness statements and repair or replacement estimation reports. In an embodiment of the present invention, the one or more media include, but not limited to, pictures or videos of the loss. In an embodiment of the present invention, the one or more claim records and pertinent information are automatically extracted from the one or more sources and provided to the source data extractor 102. In an embodiment of the present invention, the one or more claim records are extracted based on dataset definitions. Further, the one or more claim records are extracted from the one or more claim administration systems either daily, weekly or periodically as configured by one or more insurance carriers. In an embodiment of the present invention, the system 100 is an independent apparatus used by one or more insurance carriers for auditing insurance claims. Further, the source data extractor 102 residing within the system 100 provides interfaces for connecting with the one or more data sources for extraction of the one or more claim records.

The transformation engine 104 is configured to transform the received claim records to a data model using one or more data integration tools. The data model comprise information present in the one or more received claim records in a pre-defined and structured format. In an embodiment of the present invention, the transformation engine 104 transforms the received claim records such that the transformed records conform to the field labels and data value structure of the data model. The data model comprising the received claim records is uploaded, by the transformation engine 104, to the claims audit database 106. In an embodiment of the present invention, the source data extractor 102 is capable of connecting and fetching data from different heterogeneous sources and the transformation engine 104 processes and transforms the fetched data for uploading to the claims audit database 106.

The claims audit database 106 is configured to store the data model comprising the one or more claim records. In an embodiment of the present invention, the claims audit database 106 is a DataBase Management System (DBMS) such as, but not limited to, Oracle, Structured Query Language (SQL) Server, MySQL, Microsoft Access, Sybase, Informix and PostgreSQL.

The segmentation engine 108 is configured to invoke and interrogate the claims audit database 106 and categorize each claim record within the loaded data model into one or more pre-defined categories. Further, the one or more pre-defined categories are configured, by the one or more insurance carriers, in the system 100 based on, but not limited to, the type of insurance, the complexity of the claim and the type of loss. For example, in case of automobile insurance claims, the one or more pre-defined categories include, but not limited to, low complexity, clear liability/no injury, clear liability/injury, unclear liability/no injury and unclear liability/injury. In an embodiment of the present invention, the segmentation engine 108 considers each claim record and adds corresponding predefined category. Further, required activities/sequence of steps and performance expectations from claim adjuster for each claim corresponding to its category are predefined by the one or more insurance carriers. Also, the pre-defined activities/sequence of steps and performance expectations are used for auditing by the claims audit engine 108.

In an exemplary embodiment of the present invention, a claim involving a rear-end fender bender at a stop light is tagged as a low complexity category and will not require the same level of investigation as against a three cars incident with injuries which will be categorized into a different category. In an exemplary embodiment of the present invention, during operation, the segmentation engine 108 categorizes the claim based on complexity determined using loss facts and other pertinent information obtained from the first notice of loss. In an embodiment of the present invention, the source data extractor 102 extracts the claim record whenever the claim record is updated at the source (for example, the claim administration system). The segmentation engine 108 then re-categorizes, if required, the updated claim record for complexity based on the additional information updated at the source. Further, one or more managers are alerted of claims that increase in complexity to facilitate the one or more managers to determine if the claim should be reassigned to a higher skilled adjuster. For example, low complexity claims are simple claims where intervention has less chance to reduce leakage therefore the segmentation engine 108 filters the low complexity claims thereby allowing managers to focus on complex claims. Further, audits conducted by the system 100 are tailored specific to each pre-defined category and their corresponding pre-defined set of work activities/sequence of steps and performance expectations.

Once each claim record is categorized, the segmentation engine 108 invokes the claims audit engine 110. The claims audit engine 110 is a business rules management system configured to analyze and audit all claim records and flag problematic claims. In an embodiment of the present invention, the claims audit engine 110 does not audit claim records that are categorized as low complexity. Further, the claims audit engine 110 is configured to audit the one or more claim records by executing specific one or more audit rules based on the claim category and stage of the claim. Furthermore, the one or more audit rules are predefined and configured by the one or more insurance carriers in the system 100 and facilitate in checking that the required activities/sequence of steps and performance expectations are fulfilled by the claim adjusters during various stages of the claim lifecycle. In an embodiment of the present invention, the claims audit engine 110 checks specified stage field value or computes time since claim opened for determining the stage of the claim. For example, the claims audit engine 110 determines that the present stage of a claim is at the “investigate liability” stage based on value of the “number of days since opening” field extracted from the claims administration system. The claims audit engine 110 then executes the one or more audit rules corresponding to the “investigate liability” stage such as, but not limited to, “if number of days from initial contact with the claimant is greater than 7 then flag the claim red”, “if less than 50 percent investigate liability key words present in the claim file notes and days more than seven then mark the claim record with yellow flag”, “if less than 50 percent investigate liability key words present in the claim file notes and days more than fourteen then mark the claim record with red flag” and “if less than 25 percent of investigate liability keywords in the claim file notes and days more than seven then mark the claim record with red flag”. FIG. 1A is a table illustrating sample audit rules, in accordance with an exemplary embodiment of the present invention.

The claims audit engine 110 processes results of all the audit rules executed for each of the one or more claim records, marks the claim records and generates audit information and one or more alerts corresponding to each of the one or more claim records based on results of the one or more executed audit rules. In an exemplary embodiment of the present invention, the claims audit engine 110 marks each claim record using one or more flags such as, but not limited to, red, yellow and green to indicate the status of the claims based on the severity of potential problems detected in the handling of the claim and the urgency of manager review. A red flag indicates potential serious problems with the handling of the claim by the adjuster and need for manager's intervention. A yellow flag indicates the need for manager to keep a watch without necessarily intervening. A green flag indicates that the audit did not detect any potential problems with the handling of claim by the adjuster. The audit information include, but not limited to, information related to one or more audit events conducted at specific stages of the claim, results of each audit event, results of the execution of the one or more audit rules and status of the one or more claim records.

During operation, the claims audit engine 110 is configured to conduct a series of audits referred to as audit events by executing corresponding audit rules based on the category and the stage of the claim. Further, the one or more audit rules corresponding to each audit event are defined for all the categories and stages of the claims lifecycle. In an exemplary embodiment of the present invention, audit events conducted by the claims audit engine 110 include, but not limited to, activity audit, document audit, progress audit, engagement audit, vendor management audit and inconsistency audit.

In an embodiment of the present invention, the activity audit comprise tracking activities performed by claim adjusters. As part of activity audit, the claims audit engine 110 tracks the completion of key activities and records time taken to complete each activity by executing corresponding audit rules. In an embodiment of the present invention, the document audit by the claims audit engine 110 comprise auditing and recording documents submitted by the claim adjusters for each claim record/file. Further, document audit ensures that the claim adjusters obtain and review various documents required for efficiently evaluating coverage, liability and damage. In an embodiment of the present invention, the claims audit engine 110 conducts progress audits by executing audit rules that determine word count of claim file notes periodically. In an exemplary embodiment of the present invention, the word count changes are tracked at 30, 60, 90, 120 and 180 day intervals from date of assignment of the claim file. Progress audit facilitates in tracking and monitoring efficiency of the claim adjusters throughout the claims lifecycle and progress of the claims lifecycle. In an embodiment of the present invention, the claims audit engine 110 conducts engagement audit by executing audit rules that analyze key words and phrases resident in key fields and file notes provided by the source data extractor 102. In an exemplary embodiment of the present invention, during claims lifecycle, the claim adjusters provide, via the source data extractor 102, file notes that may comprise their thought process in free form text which are further provided to the claims audit engine 110 for analyzing the keywords and phrases present in them. For example, during the investigate liability stage, the claim adjusters would be expected to document a statement about the accident details and scene description which is provided to the claims audit engine 110 for engagement audit. Additionally, engagement audit monitors claimant sentiment, as documented by the adjuster in file notes and facilitates avoiding adverse customer experience.

In an embodiment of the present invention, the claims audit engine 110 conducts vendor management audits by executing audit rules that conduct activity, document and engagement audits specific to vendor management to facilitate managing vendor costs. In an embodiment of the present invention, the claims audit engine 110 conduct inconsistency audit by executing audit rules that facilitates tracking inconsistencies within a claim file which then flags errors in analysis, judgment or data entry. For example, in case of damages to the rear end of a vehicle, it is unlikely that the driver of the vehicle should be considered at fault. The claims audit engine 110 compares the vehicle impact point to the liability percentage provided by the adjuster and flags the claim if the adjuster considered the driver at fault during evaluation.

In an exemplary embodiment of the present invention, the insured customer contacts the insurer's call center to report a claim. Further, loss facts obtained by the call center agent are entered into the claim administration system to set up the claim. For example, loss facts entered by the call center agent are “3 vehicle incident, at intersection with 4 way stop sign, injuries reported yet no injured party transported to hospital by emergency care, injured party has obtained an attorney, there were witnesses on the scene.” The loss facts are then extracted by the source data extractor 102 and after transformation loaded to the CA database 106 for categorization. The segmentation engine 108 categorizes the claim as “unclear liability/injuries/attorney represented”. Further, the auto physical damage and liability portion of the claim is assigned to an adjuster A, and the injury portion to an adjuster B who also manages attorney representation. The claim handling protocols/best practices are predefined by the insurer for handling claims based on the nature and category of the claim. The existing claim administration systems are tailored to assist adjusters to manage workflow, facilitate data entry along various stages of the claims lifecycle and submit pre-defined activities thereby formalizing a sub-set of the steps the adjuster should follow to complete the claim. Further, claim handling protocols/best practices and activities form the expectations of how the adjuster should handle the claim based on the complexity of the claim/category. The claims audit engine 110 conducts various audits throughout the claims lifecycle to validate that the expectations from the adjusters are fulfilled.

Below are examples of audits conducted by the claims audit engine 110 on the exemplary claim record mentioned above that is flagged red indicating potential serious problems with the handling of the claim by the adjuster and need for the manager's intervention. In an embodiment of the present invention, on conducting document audit and executing corresponding audit rules, the claims audit engine 110 determines that the witness statements, injured party statement, scene photos and official reports are not present in the file after 30 days from assignment. In an embodiment of the present invention, on conducting progress audit, the claims audit engine 110 determines that the mandatory fields such as, first initial, last name, date of birth, gender and social security number that are required to determine if the injured party is a ‘Medicare’ recipient are not populated after 14 days from assignment. The progress audit facilitates in determining progress by the adjuster A at periodic intervals based on the key word counts.

In an embodiment of the present invention, for the exemplary claim record mentioned above, on conducting engagement audit, the claims audit engine 110 determines that the adjuster A engaged a non-preferred vendor for an accident recreation study without justification using file notes. By executing audit rules corresponding to engagement audit, the claims audit engine 110 determined that only 50% of expected key words are present in the file notes and words such as ‘cost’, ‘benefit’, ‘non-preferred’, ‘impact’ and ‘budget’ are absent. On conducting the inconsistency audit, the claims audit engine 110 determined that adjuster indicated that the insured was majorly at fault (“75% entered in the “liability” field), yet the driver of the second vehicle was issued a ‘fail to yield” citation in the file notes. On conducting safety net activity audit, the claims audit engine 110 determined that that adjuster B has not acknowledged ‘upcoming trial date’ after seven days. The engagement audit conducted by the claims audit engine 110 facilitates in determining that the adjuster B has not taken the time to define or document a settlement strategy due to absence of key words/string text such as ‘settlement range’, ‘range of exposure’, ‘anchor offer’, ‘to resolve case’, ‘pain and suffering’ expected to be found in file notes as file approaches settlement stage.

The claims audit engine 110 is connected with one or more communication channels interface to automatically forward the one or more generated alerts related to each of the one or more claim records to the one or more managers via one or more communication channels. The generated one or more alerts include, but not limited to, summary of the results of the audit conducted by the claims audit engine 110 for each of the one or more claim records. The one or more communication channels include, but not limited to, electronic mails, short messaging service (SMS), facsimile, instant messengers and any other suitable communication channel.

In an embodiment of the present invention, one or more users such as, but not limited to, the one or more managers access an interactive user interface provided by the user interface manager 112 for monitoring the claims managed by them. Further, the user interface manager 112 is configured to provide at least one: of the generated audit information and the one or more alerts in the form of summarized dashboards and detailed insights via the user interface. Furthermore, the one or more managers access the user interface via an application or a website using one or more electronic communication devices. The user interface manager 112 renders various interactive screens such as, but not limited to, manager dashboard page, claim insights page, audit insight page and adjusters performance page on the display screen of the one or more electronic communication devices.

FIG. 1B is a detailed block diagram of the user interface manager 112, in accordance with an exemplary embodiment of the present invention. The user interface manager 112 comprise a manager dashboard 114, a claim insights module 116, an audit insight module 118 and an adjusters performance module 120. Each manager has a personalized manager dashboard page which is rendered by the manager dashboard 114 on the display screen of the manager's electronic communication device. The manager dashboard page is accessible by providing authentication details such as username and password. On accessing the manager dashboard page, the manager is able to access claims that are managed by him. In an embodiment of the present invention, the manager dashboard 114 provides one or more summary views to the manager based on, but not limited to, claim status and audit results. FIG. 1C is a screenshot of the manager dashboard page illustrating summary of claims based on their status, in accordance with an exemplary embodiment of the present invention. In an exemplary embodiment of the present invention, the status of the claims is either one of, but not limited to, new, open and close. FIG. 1D is a screenshot of the manager dashboard page illustrating summary of claims based on flagging from the audit, in accordance with an exemplary embodiment of the present invention. In an exemplary embodiment of the present invention, active/open claims are marked as, but not limited to, red, yellow and green after auditing based on the severity of potential problems detected in their handling. Further, the claims marked red have issues that need attention of the one or more users.

In an embodiment of the present invention, the summarization in both the views illustrated in FIGS. 1C and 1D are followed by a table containing all the claims that were audited. Further, each claim is presented in a separate row within the table as illustrated in the FIGS. 1C and 1D. Furthermore, claims marked with red flag are provided with a description of the issues occurring on the claim file. Also, the manager dashboard 114 provides one or more options to select the claim and view additional details, send instructions to the claim adjusters, sort claims across multiple dimensions (for example, adjuster, category, injury type) and view trends. FIG. 1E is a screenshot of the claim insights page illustrating claim details, in accordance with an exemplary embodiment of the present invention. Selecting any of the claims listed in the table on the manager dashboard under claim or audit summary displays details of the selected claims as illustrated in FIG. 1E. Further, based on the audit conducted by the claims audit engine 110, a flag indicating the audit result of the claim is also displayed along with a brief description of reasons for the failed audit event, if any, and a link to the claim file.

In an embodiment of the present invention, the user interface manager 112 is configured to provide options to the managers to view their portfolio via claim insights page provided by the claim insight module 116. The claim insights module 116 facilitates in providing the manager with consolidated and graphical analysis of claims managed by him along with their status by rendering the claim insights page on the electronic communication device. FIG. 1F is a screenshot of claim insights page illustrating options for filtering the claims, in accordance with an exemplary embodiment of the present invention. Further, a dropdown list referred to as “Claims By Segment” is provided for filtering the pie chart based on the category of the claim and viewing number of claims in each category/segment. Furthermore, a dropdown list referred to as “Claims By Paid To Date Amount” is provided to view claim amounts paid under different categories of claims. FIG. 1G is a screenshot illustrating a pie chart populated by filtering the claims based on attorney involvement, in accordance with an exemplary embodiment of the present invention. FIG. 1H is a screenshot of a weekly claim status report, in accordance with an exemplary embodiment of the present invention. The audit insights module 118 facilitates in providing the manager with consolidated and graphical analysis of claims, based on audit results, which are managed by him by rendering the audit insights page on the electronic communication device. FIG. 1I is a screenshot of audit insights page provided by the audit insight module 118, in accordance with an exemplary embodiment of the present invention. Further, a dropdown list is provided for filtering the pie chart based on types of audit events.

The adjuster performance module 120 provides options such as, but not limited to, menu links that enable the one or more users to compare all claim records associated with an adjuster and perform analysis to generate analytical reports related to, but not limited to, claim records and adjuster performance. FIG. 1J is a screenshot of the adjuster performance page, in accordance with an exemplary embodiment of the present invention. Further, the adjuster performance page provides options to view summary of performance of all the adjusters across key attributes and metrics. Furthermore, selecting an adjuster from the list of the adjuster displayed on the adjuster performance page provides a detailed claim-wise performance of the selected adjuster, historical performance of the adjuster against key attributes on all assigned files and adjusters' strengths and opportunities for improvement. In an embodiment of the present invention, performance of adjusters is tracked across key attributes, such as, but not limited to, vendor management, reserve management, settlement and general.

In an exemplary embodiment of the present invention, for tracking the adjusters' performance with respect to vendor management, the claims audit engine 110 monitors the number of preferred and non-preferred vendor engagements by the claim adjusters and number of alerts with yellow and red statuses when engaging with non-preferred vendors. In an exemplary embodiment of the present invention, for tracking the adjusters' performance with respect to reserve management, the claims audit engine 110 monitors claims where the claim adjuster increased reserves more than three times, files where first reserve minus the final incurred was less than eighty percent and files in which reserve is less than ten percent of large loss threshold. In an exemplary embodiment of the present invention, for tracking the adjusters' performance with respect to settlement attribute, the claims audit engine 110 monitors those claims in which final payment minus the anchor offer is greater than twenty-five percent and claims settled with more than ninety-five percent of the reserve. In an exemplary embodiment of the present invention, for tracking the adjusters' performance with respect to general attributes, the claims audit engine 110 monitors the claim files having red status and the number of days taken by each claim adjuster to close files in each category.

In an embodiment of the present invention, the claims audit engine 110 comprise an in-built analytics tool which analyzes the information generated on execution of audit rules and facilitates presenting the same in a meaningful manner, via the user interface provided by the user interface manager 112, to the managers and/or the claim adjusters. In another embodiment of the present invention, the claims audit engine 110 interacts with one or more external analytics tool for analyzing the information generated on execution of the audit rules.

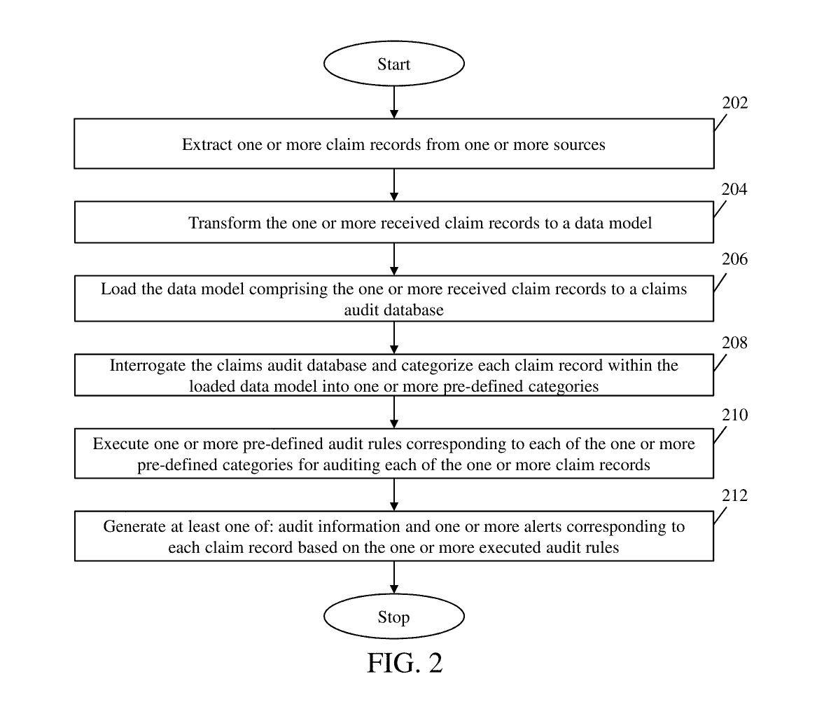

FIG. 2 is a flowchart illustrating a method for auditing insurance claims, in accordance with an embodiment of the present invention.

At step 202, one or more claim records from one or more sources are extracted. The one or more sources include, but not limited to, existing systems such as claim administration systems employed by one or more insurance carriers for managing claims, document repositories, media repositories and third party sources. The media repositories provide media such as, but not limited to, images, audio files and video files. The third party sources provide information including, but not limited to, industry standards, weather information and maps. In an embodiment of the present invention, the claim records and pertinent information are extracted from one or more data feeds, documents and media provided by the one or more sources. In an embodiment of the present invention, the one or more data feeds include, but not limited to, information in a predefined format that is prepared and transmitted by existing systems or third party sources. In an embodiment of the present invention, the one or more documents include, but not limited to, first loss notice, medical records, medical bills, official reports such as police reports and witness statements and repair or replacement estimation reports. In an embodiment of the present invention, the one or more media include, but not limited to, pictures or videos of the loss.

At step 204, the extracted claim records are transformed to a data model using one or more data integration tools. The data model comprise information present in the one or more received claim records in a pre-defined and structured format. In an embodiment of the present invention, the extracted claim records are transformed such that the transformed records conform to the field labels and data value structure of the data model. The data model comprising the extracted claim records is then uploaded to a claims audit database.

At step 206, the data model is loaded to the claims audit database. In an embodiment of the present invention, the claims audit database is a DataBase Management System (DBMS) such as, but not limited to, Oracle, Structured Query Language (SQL) Server, MySQL, Microsoft Access, Sybase, Informix and PostgreSQL.

At step 208, the claims audit database is invoked and interrogated and each claim record within the loaded data model is categorized into one or more pre-defined categories. Further, the one or more categories are defined by the one or more insurance carriers based on, but not limited to, type of insurance, complexity of the claim and type of loss.

For example, in case of automobile insurance claims, the predefined categories include, but not limited to, low complexity, clear liability/no injury, clear liability/injury, unclear liability/no injury and unclear liability/injury. In an embodiment of the present invention, each claim record is considered independently and categorized into a predefined category. Further, required activities/sequence of steps and performance expectations from claim adjuster for each claim corresponding to its category are predefined by the one or more insurance carriers. Furthermore, the pre-defined activities/sequence of steps and performance expectations are used for auditing the claim records.

At step 210, one or more predefined audit rules corresponding to each of the one or more predefined categories are executed for auditing each of the one or more claim records. Further, specific audit rules are executed based on the claim category and stage of the claim. In an embodiment of the present invention, specified stage field value is checked or time since claim opened is computed for determining the stage of the claim. Further, the results of all the executed audit rules are processed and if required the claim is flagged for review by one or more managers. In an exemplary embodiment of the present invention, each claim record is marked after the audit using predefined flags such as, but not limited to, red, yellow and green to indicate the status of the claims based on the severity of potential problems detected in the handling of the claim and the urgency of manager review. A red flag indicates potential serious problems with the handling of the claim by the adjuster and need for manager's intervention. A yellow flag indicates the need for manager to keep a watch without necessarily intervening. A green flag indicates that the audit did not detect any potential problems with the handling of claim by the adjuster.

During operation, a series of audits referred to as one or more audit events are conducted by executing corresponding audit rules. Further, the one or more audit rules corresponding to each audit event are predefined for all the categories and stages of the claims lifecycle. In an exemplary embodiment of the present invention, the one or more audit events include, but not limited to, activity audit, document audit, progress audit, engagement audit, vendor management audit and inconsistency audit.

At step 212, audit information and one or more alerts corresponding to each of the one or more claim records are generated based on results of the one or more executed audit rules. The audit information corresponding to the one or more claim records include, but not limited to, information related to one or more audit events conducted at specific stages of the claim, results of each audit event, results of the execution of the one or more audit rules and status of the one or more claim records. The one or more alerts include, but not limited to, summary of the results of the audit for each of the one or more claim records. On execution of the one or more audit rules corresponding to the one or more audit events, each claim record is marked with the predefined flags based on the result of the executed one or more audit rules. The one or more alerts are then generated corresponding to each of the one or more audited claim records. The one or more generated alerts are forwarded to the one or more managers via one or more communication channels. The one or more communication channels include, but not limited to, electronic mails, short messaging service (SMS), facsimile, instant messengers and any other suitable communication channel. In an embodiment of the present invention, the method for auditing the insurance claims further comprises providing at least one: of the generated audit information and the one or more generated alerts in the form of summarized dashboards and detailed insights via a user interface.

In an embodiment of the present invention, one or more users such as, but not limited to, the one or more managers access the user interface provided by a user interface manager for monitoring the claims managed by them. Further, the one or more managers access the user interface via an application or a website using one or more electronic communication devices. Furthermore, the user interface manager provides the user interface and renders various interactive screens such as, but not limited to, manager dashboard page, claim insights page, audit insight page and adjusters performance page on the display of the one or more electronic communication devices. The one or more managers are thereby provided options to view all the claims, the generated audit information corresponding to the claims assigned and monitor the performance of the adjusters working under them.

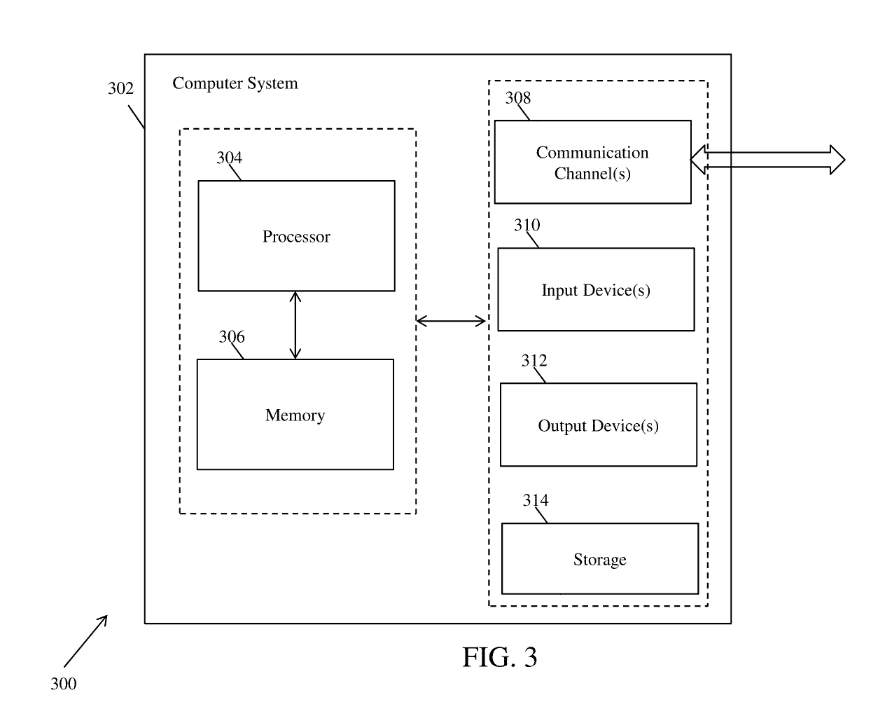

FIG. 3 illustrates an exemplary computer system for auditing insurance claims, in accordance with an embodiment of the present invention.

The computer system 302 comprises a processor 304 and a memory 306. The processor 304 executes program instructions and may be a real processor. The processor 304 may also be a virtual processor. The computer system 302 is not intended to suggest any limitation as to scope of use or functionality of described embodiments. For example, the computer system 302 may include, but not limited to, a general-purpose computer, a programmed microprocessor, a micro-controller, a peripheral integrated circuit element, a mobile device such as, but not limited to, a smartphone or a tablet and other devices or arrangements of devices that are capable of implementing the steps that constitute the method of the present invention. In an embodiment of the present invention, the memory 306 may store software and data for implementing various embodiments of the present invention. The computer system 302 may have additional components. For example, the computer system 302 includes one or more communication channels 308, one or more input devices 310, one or more output devices 312, and storage 314. An interconnection mechanism (not shown) such as a bus, controller, or network, interconnects the components of the computer system 302. In various embodiments of the present invention, operating system software (not shown) provides an operating environment for various softwares executing in the computer system 302, and manages different functionalities of the components of the computer system 302.

The communication channel(s) 308 allow communication over a communication medium to various other computing entities. The communication medium provides information such as program instructions, or other data in a communication media. The communication media includes, but not limited to, wired or wireless methodologies implemented with an electrical, optical, RF, infrared, acoustic, microwave, bluetooth or other transmission media.

The input device(s) 310 may include, but not limited to, a keyboard, mouse, pen, joystick, trackball, a voice device, a scanning device, or any another device that is capable of providing input to the computer system 302. In an embodiment of the present invention, the input device(s) 310 may be a sound card or similar device that accepts audio input in analog or digital form. The output device(s) 312 may include, but not limited to, a user interface on CRT, LCD or display screen, printer, speaker, CD/DVD writer, or any other device that provides output from the computer system 302.

The storage 314 may include, but not limited to, magnetic disks, magnetic tapes, CD-ROMs, CD-RWs, DVDs, flash drives or any other medium which can be used to store information and can be accessed by the computer system 302. In various embodiments of the present invention, the storage 314 contains program instructions for implementing the described embodiments.

The present invention may suitably be embodied as a computer program product for use with the computer system 302 or a network of more than one computer system 302 that are interconnected. The method described herein is typically implemented as a computer program product, comprising a set of program instructions which is executed by the computer system 302 or any other similar device. The set of program instructions may be a series of computer readable codes stored on a tangible medium, such as a computer readable storage medium (storage 314), for example, diskette, CD-ROM, ROM, flash drives or hard disk, or transmittable to the computer system 302, via a modem or other interface device, over either a tangible medium, including but not limited to optical or analogue communications channel(s) 308. The implementation of the invention as a computer program product may be in an intangible form using wireless techniques, including but not limited to microwave, infrared, bluetooth or other transmission techniques. These instructions can be preloaded into a system or recorded on a storage medium such as a CD-ROM, or made available for downloading over a network such as the internet or a mobile telephone network. The series of computer readable instructions may embody all or part of the functionality previously described herein.

The present invention may be implemented in numerous ways including as an apparatus, method, or a computer program product such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims.

We claim:

1. A system for auditing insurance claims, the system comprising:
a source data extractor configured to extract one or more claim records from one or more sources;
a transformation engine configured to:
transform the one or more received claim records to a data model, wherein the data model comprise information present in the one or more received claim records in a pre-defined and structured format; and
load the data model to a claims audit database;
a segmentation engine configured to interrogate the claims audit database and categorize each claim record within the loaded data model into one or more pre-defined categories; and
a claims audit engine configured to:
execute one or more pre-defined audit rules corresponding to each of the one or more categories for auditing each of the one or more claim records; and
generate at least one of: audit information and one or more alerts corresponding to each of the one or more claim records based on results of the one or more executed audit rules.

2. The system of claim 1, wherein the one or more sources comprise claim administration systems employed by one or more insurance carriers, document repositories, media repositories and third party sources.

3. The system of claim 1, wherein the one or more pre-defined categories are configured by one or more insurance carriers based on type of insurance, complexity of claim and type of loss.

4. The system of claim 1, wherein the one or more audit rules are executed based on category and stage of each of the one or more claim records.

5. The system of claim 1, wherein the claims audit engine executes the one or more audit rules corresponding to one or more audit events and further wherein the one or more audit events comprise activity audit, document audit, progress audit, engagement audit, vendor management audit and inconsistency audit.

6. The system of claim 1, wherein the generated audit information comprise information related to one or more audit events conducted at specific stages of the claim, results of each audit event, results of the execution of the one or more audit rules and status of the one or more claim records.

7. The system of claim 1, wherein the one or more alerts comprise summary of the results of the audit conducted by the claims audit engine for each of the one or more claim records.

8. The system of claim 1, wherein the one or more alerts corresponding to each of the one or more claim records are forwarded via one or more communication channels.

9. The system of claim 8, wherein the one or more communication channels comprise electronic mails, short messaging service, facsimile and instant messengers.

10. The system of claim 1 further comprising a user interface manager configured to provide at least one: of the generated audit information and the one or more alerts in the form of summarized dashboards and detailed insights.

11. A computer-implemented method for auditing insurance claims, via program instructions stored in a memory and executed by a processor, the computer-implemented method comprise:
extracting one or more claim records from one or more sources;
transforming the one or more received claim records to a data model, wherein the data model comprise information present in the one or more received claim records in a pre-defined and structured format;
loading the data model to a claims audit database;
interrogating the claims audit database and categorizing each claim record within the loaded data model into one or more pre-defined categories;
executing one or more pre-defined audit rules corresponding to each of the one or more pre-defined categories for auditing each of the one or more claim records; and
generating at least one of: audit information and one or more alerts corresponding to each of the one or more claim records based on results of the one or more executed audit rules.

12. The computer-implemented method of claim 11, wherein the one or more sources comprise claim administration systems employed by one or more insurance carriers, document repositories, media repositories and third party sources.

13. The computer-implemented method of claim 11, wherein the one or more pre-defined categories are configured by one or more insurance carriers based on type of insurance, complexity of claim and type of loss.

14. The computer-implemented method of claim 11, wherein the one or more audit rules are executed based on category and stage of each of the one or more claim records.

15. The computer-implemented method of claim 11, wherein the one or more audit rules are executed corresponding to one or more audit events and further wherein the one or more audit events comprise activity audit, document audit, progress audit, engagement audit, vendor management audit and inconsistency audit.

16. The computer-implemented method of claim 11, wherein the audit information comprise information related to one or more audit events conducted at specific stages of the claim, results of each audit event, results of the execution of the one or more audit rules and status of the one or more claim records.

17. The computer-implemented method of claim 11, wherein the one or more alerts comprise summary of the results of the audit for each of the one or more claim records.

18. The computer-implemented method of claim 11, wherein the one or more alerts corresponding to each of the one or more claim records are forwarded via one or more communication channels.

19. The computer-implemented method of claim 18, wherein the one or more communication channels comprise electronic mails, short messaging service (SMS), facsimile and instant messengers.

20. The computer-implemented method of claim 11 further comprising providing at least one: of the generated audit information and the one or more generated alerts in the form of summarized dashboards and detailed insights.

21. A computer program product for auditing insurance claims, the computer program product comprising:
a non-transitory computer-readable medium having computer-readable program code stored thereon, the computer-readable program code comprising instructions that when executed by a processor, cause the processor to:
extract one or more claim records from one or more sources;
transform the one or more received claim records to a data model, wherein the data model comprise information present in the one or more received claim records in a pre-defined and structured format;
load the data model to a claims audit database;
interrogate the claims audit database and categorizing each claim record within the loaded data model into one or more pre-defined categories;
execute one or more audit rules corresponding to each of the one or more pre-defined categories for auditing each of the one or more claim records; and
generate at least one of: audit information and one or more alerts corresponding to each of the one or more claim records based on results of the one or more executed audit rules.
